(19) United States
(12) Patent Application Publication
(10) Pub. No.: US 2012/0031269 A1
(43) Pub. Date: Feb. 9, 2012

(54) METHOD AND DEVICE FOR PURIFYING A GAS STREAM CONTAINING CARBON DIOXIDE

(75) Inventors: Dieter Mihailowitsch, Geretsried (DE); Torsten Stoffregen, Dresden (DE); Martin Weiss, Freital (DE)

(73) Assignee: Linde-KCA-Dresden GmbH, Dresden (DE)

(21) Appl. No.: 13/202,098

(22) PCT Filed: Feb. 12, 2010
(86) PCT No.: PCT/EP2010/000880

§ 371 Date: Oct. 27, 2011

(30) Foreign Application Priority Data
Feb. 19, 2009 (DE) 10 2009 009 476.8

(51) Int. Cl. B01D 53/14

(52) U.S. Cl. 95/156; 261/34.1

(57) ABSTRACT

A method and a device for purifying a carbon-dioxide-containing gas stream are described, in which the gas stream is first subjected in a lower section (3) of an absorption column (1) to a prescrubbing for conditioning the gas stream and subsequently in an upper section (8) of the absorption column (1) the carbon dioxide is scrubbed out from the gas stream at least in part with a scrubbing liquid. For improving the construction of the absorption column it is proposed that the entire scrubbing liquid loaded with the carbon dioxide which is scrubbed out is taken off from the absorption column (1) and fed to a receiver tank (11) arranged outside the absorption column (1) and subsequently applied to a scrubbing liquid pump (12) which pumps the scrubbing liquid to a scrubbing medium regeneration stage.

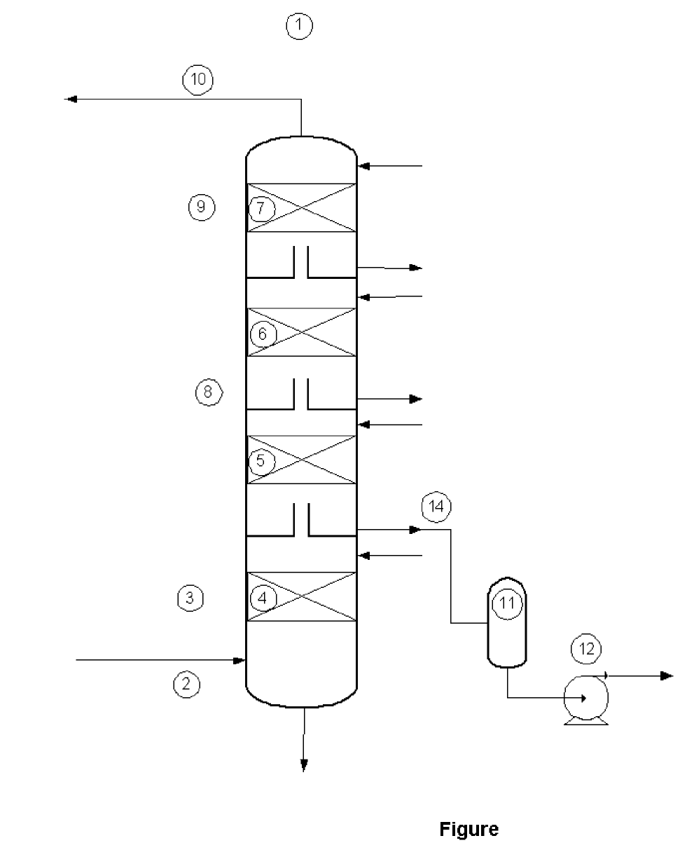

The invention relates to a method for purifying a carbon-dioxide-containing gas stream, wherein the gas stream is first subjected in a lower section of an absorption column to a prescrubbing for conditioning the gas stream and subsequently in an upper section of the absorption column the carbon dioxide is scrubbed out from the gas stream at least in part with a scrubbing liquid, and also to a device for carrying out the method.

For securing the energy supply of a national economy, power plants, that is to say industrial plants for providing, in particular electrical, and in part additional thermal, power, are essential. In such power stations, primary energy is used which, after appropriate conversion, is provided as usable energy. In this process, generally gas streams occur which cannot be released to the environment without further purification steps. In particular, in thermal power stations in which fossil fuels, e.g. coal, petroleum or natural gas, are burnt, waste gas streams customarily occur which are termed flue gases and contain environmentally-damaging components. As an environmentally-damaging component, increasingly CO₂ is being considered which is categorized as a climate-damaging gas.

Very recently, novel power plant designs have been proposed in which CO₂ is separated off and fed to further use.

The purpose of these novel designs is to compress the carbon dioxide which is formed in the combustion of the fossil fuels, after it has separated off, in suitable deposits, in particular in certain rock layers or brine-bearing layers, and thereby limit the discharge of carbon dioxide to the atmosphere. The climate-damaging action of greenhouse gases such as carbon dioxide is intended to be reduced thereby. The current designs are called in the specialist field carbon, capture and sequestration technology (CCS technology).

Carbon-dioxide-containing gas streams also occur in other large-scale fired plants which are operated using fossil fuels. These include, e.g. industrial furnaces, steam kettles and similar large-scale thermal plants for power or heat generation.

For scrubbing out the carbon dioxide from unpressurized flue gases, amine-based scrubbing media, e.g., can be used. In order to be able to make the scrubbing process as efficient as possible, the flue gas stream, before entry into the actual scrubbing section, must be appropriately conditioned. For this the flue gas stream must be cooled down to the suitable temperature. Furthermore, traces of harmful components such as, e.g., SO₂, must be removed from the flue gas stream before the actual CO₂ scrubbing. This is generally achieved using a prescrubber with water and optionally basic additives (depending on the traces and content thereof). The prescrubber can be erected as a separate apparatus or integrated into the actual scrubbing as an additional apparatus.

Both variants, however, exhibit specific disadvantages in the designs implemented to date.

For instance, separate erection of the prescrubber requires, for example, a large plant floor space. In addition, owing to the necessary additional piping, an additional pressure drop occurs. Finally, the gas distribution must be taken into consideration twice on a large column cross section (prescrubber and scrubbing column).

On the other hand, in the case of a prescrubber erected integrated into the absorption column, high loads occur within the absorption column owing to the pump receiver of the actual scrubbing section. Furthermore, owing to the required liquid volume for the pump feed, additional column height is required. Again this has adverse effects on foundations, statics and wall thicknesses.

It is an object of the present invention to design a method of the type mentioned at the outset and also a device for carrying out the method in such a manner that an industrial construction of the absorption column can be achieved in an economical manner.

This object is achieved according to the invention in terms of the method in that the entire scrubbing liquid loaded with the carbon dioxide which is scrubbed out is taken off from the absorption column and fed to a receiver tank arranged outside the absorption column and subsequently applied to a scrubbing liquid pump which pumps the scrubbing liquid to a scrubbing medium regeneration stage.

By integrating the prescrubbing into the absorption column with simultaneous removal of the necessary liquid volume for the pump feed, the said disadvantages of previous methods with a separate erection of the prescrubber with respect to space requirement, pressure drop and faulty distribution are avoided. At the same time, the problems of previous methods with integrated erection of the apparatus for prescrubbing with respect to additional loads owing to the liquid volumes for the pump feed are bypassed.

In a particularly preferred embodiment of the invention, the prescrubbing is carried out in a section of the absorption column which is designed as the lowest absorber bed.

The absorption column comprises, e.g., in total four absorption beds, wherein the uppermost absorption bed serves for backwashing, whereas the two central absorption beds are provided for the actual scrubbing out of the carbon dioxide. The lowest absorption bed serves for prescrubbing the carbon-dioxide-containing gas stream entering into the absorption column in the bottom region.

Advantageously, a physically and/or chemically acting scrubbing medium is used for the scrubbing liquid for separating off carbon dioxide. In particular, a scrubbing medium which contains at least one amine is suitable therefor.

Particular advantages result when the invention is applied to large-scale fired plants, in particular coal power plants. In this case, therefore, the gas stream which is to be purified is formed of a carbon-dioxide-containing exhaust gas stream of a large-scale fired plant, in particular a power plant, wherein fossil fuels are burnt with air in the large-scale fired plant.

The carbon dioxide which is scrubbed out can be treated and fed to a use and/or storage. For this, the carbon dioxide can be transported, for example, via piping to a use site and there forced into rock layers of the subsurface, or into brine-bearing layers.

The scrubbing is preferably carried out at about atmospheric pressure, in particular at a pressure between −100 mbar and +100 mbar.

Furthermore, the scrubbing proceeds advantageously at a temperature in the range from 20 to 80° C., particularly preferably in the range from 30 to 45° C. The scrubbing water cycle of the prescrubbing is expediently cooled by means of cooling water or cold water from a refrigeration plant.

Advantageously, all liquids can be fed to further receiver vessels from intermediate withdrawals, in particular side take-offs and intermediate cycles, and bottom withdrawals of the absorption column.

According to a development of the inventive concept, the receiver vessel is used as collection reservoir for the scrubbing medium of the entire plant (what is called hold-up).

The invention further relates to a device for purifying a carbon-dioxide-containing gas stream having an absorption column which comprises a lower section for prescrubbing the gas stream and an upper section for the at least partial scrubbing of the carbon dioxide from the gas stream.

The object in question is achieved in terms of the device in that the absorption column is connected via at least one liquid take-off to a receiver vessel which is arranged outside the absorption column and downstream of which is connected a scrubbing liquid pump.

According to a development of the concept of the invention, all liquid take-offs of the absorption column can be connected to further receiving vessels.

Preferably, the section for prescrubbing the gas stream is formed from the lowest absorption bed of the absorption column.

The absorption column expediently has a diameter of at least 3 m, in particular 10 to 25 m, or an equivalent rectangular cross section.

The invention is suitable for all conceivable large-scale fired plants in which carbon-dioxide-containing gas streams occur. These include, e.g., power plants operated with fossil fuels, industrial furnaces, steam kettles and similar large-scale thermal plants for power and/or heat generation. In particular, the invention is suitable for what is termed low-CO₂ coal power plants using the post-combustion capture method.

Hereinafter the invention will be described in more detail with reference to an exemplary embodiment shown diagrammatically in the figure.

The FIGURE shows an absorption column having an integrated prescrubber.

The carbon-dioxide-containing flue gas from a coal power plant is introduced via line 2 into the lower section 3 of the absorption column 1. In this section 3 an absorption bed 4 is arranged which is one of in total four absorption beds 4, 5, 6, 7 of the absorption column 1. In section 3, prescrubbing of the gas stream takes place in which the gas stream is cooled to the temperature of approximately 30 to 35° C. which is desired for the actual CO₂ scrubbing and substantially freed from traces of harmful components, in particular SO₂. For this, water, possibly containing basic additives, e.g. ammonium compounds, is trickled over the absorption bed 3. The gas stream which is thus prepurified and cooled is subjected to the actual CO₂ scrubbing in the absorption column 1 section 8 situated thereabove. Here, a majority, in particular more than 90% by volume, of the carbon dioxide is scrubbed out of the gas stream. For this, an amine-based scrubbing liquid is trickled over the absorption beds 5 and 6. Above the section 8 is connected further an uppermost section 9 of the absorption column 1 having an absorption bed 7. This section 9 serves for backwashing. The gas stream which is very largely purified from carbon dioxide is finally taken off as clean gas via line 10 and can be released to the environment. The scrubbing liquid which is loaded with the carbon dioxide is taken off from the absorption column 1 via line 14 and fed to the receiver vessel 11. The receiver vessel 11 is erected at a suitable height above the scrubbing liquid pump 12, in order to serve as feed for the scrubbing liquid pump. The scrubbing liquid pump 12 pumps the loaded scrubbing liquid to a scrubbing medium regeneration stage which is not shown in the figure. From there the regenerated scrubbing liquid can again be recirculated to the uppermost section 9 of the absorption column 1.

1. Method for purifying a carbon-dioxide-containing gas stream, wherein the gas stream is first subjected in a lower section of an absorption column to a prescrubbing for conditioning the gas stream and subsequently in an upper section of the absorption column the carbon dioxide is scrubbed out from the gas stream at least in part with a scrubbing liquid, characterized in that the entire scrubbing liquid loaded with the carbon dioxide which is scrubbed out is taken off from the absorption column (1) and fed to a receiver tank (11) arranged outside the absorption column (1) and subsequently applied to a scrubbing liquid pump (12) which pumps the loaded scrubbing liquid to a scrubbing medium regeneration stage.

2. Method according to claim 1, characterized in that the prescrubbing is carried out in a section (3) of the absorption column (1) which is designed as the lowest absorber bed (4).

3. Method according to claim 1, characterized in that the gas stream is formed of a carbon-dioxide-containing exhaust gas stream of a large-scale fired plant, in particular a power plant.

4. Method according to claim 1, characterized in that the carbon dioxide which is scrubbed out is fed to a use or storage.

5. Method according to claim 1, characterized in that a physically and/or chemically acting scrubbing medium is used for the scrubbing liquid.

6. Method according to claim 1, characterized in that a scrubbing medium is used which contains at least one amine as a component.

7. Method according to claim 1, characterized in that the scrubbing is carried out at a pressure between −100 mbar and +100 mbar.

8. Method according to claim 1, characterized in that further liquids are fed from intermediate withdrawals, in particular side take-offs and intermediate cycles, and bottom withdrawals of the absorption column (1) in each case to a further receiver vessel (11).

9. Method according to claim 1, characterized in that the receiver vessel (11) is used as a collection reservoir for the column hold-up (liquid contents of all column internals).

10. Method according to claim 1, characterized in that the receiver vessel (11) is used as collection reservoir for the scrubbing medium of the entire plant (what is called hold-up).

11. Device for purifying a carbon-dioxide-containing gas stream having an absorption column which comprises a lower section for prescrubbing the gas stream and an upper section for the at least partial scrubbing of the carbon dioxide from the gas stream, characterized in that the absorption column (1) is connected via at least one liquid take-off to a receiver vessel (11) which is arranged outside the absorption column (1) and downstream of which is connected a scrubbing liquid pump (12).

12. Device according to claim 10, characterized in that the section (3) for prescrubbing the gas stream is formed from the lowest absorption bed (4) of the absorption column (1).

13. Device according to claim 10, characterized in that the absorption column (1) has a diameter of at least 3 m, in particular 10 to 25 m, or an equivalent rectangular cross section.
